(19) United States
(12) Patent Application Publication
(10) Pub. No.: US 2018/0341570 A1
(43) Pub. Date: Nov. 29, 2018

(54) Repositioning HDMI Content Based on Content Changes

(71) Applicant: EVA Automation, Inc., Redwood City, CA (US)

(72) Inventor: Gaylord Yu, San Francisco, CA (US)

(73) Assignee: EVA Automation, Inc., Redwood City, CA (US)

(21) Appl. No.: 15/607,617

(22) Filed: May 29, 2017

(51) Int. Cl. G06F 11/34; G09G 5/00; G09G 5/38; G09G 5/32

(52) U.S. Cl. CPC G06F 11/3485; G09G 5/32; G09G 5/38; G09G 5/006

(57) ABSTRACT

In response to identifying a type of change in audio/video (A/V) content that was received from a content source, an A/V hub may generate display instructions specifying a display layout of the A/V content on a display in an A/V display device, and may provide the display instructions and the A/V content to the display to dynamically modify the display of the A/V content. For example, the A/V hub may display the A/V content in a central window of the display. This may involve swapping the A/V content with other A/V content that was previously displayed in the central window, and the other A/V content may be displayed in a tiled window (which may be smaller than the central window and may be located proximate to a periphery of the display). Alternatively, the A/V hub may display the A/V content in a new tiled window of the display.

### BACKGROUND

### Field

The described embodiments relate to display techniques, including dynamically displaying audio/video (A/V) content in a tiled window based on types of changes in the A/V content.

### Related Art

The versatility and capabilities of consumer-electronics or electronic devices is increasing their popularity. For example, the communication capabilities of these electronic devices allow users to access content from a wide variety of sources, including high-definition content.

However, while the electronic devices typically include high-resolution displays that allow users to view high-definition content, the interface circuits and the communication bandwidth in many electronic devices can pose obstacles to simultaneous viewing of high-definition content.

In addition, the user interfaces associated with many electronic devices can be difficult to use. For example, the process of identifying content from a particular source, selecting the content and having the content piped to a particular display often requires that users perform multiple operations. This convoluted process is time-consuming and cumbersome. Moreover, users often make mistakes when attempting to navigate through a complicated set of options in different menus, which frustrates users and degrades their user experience.

### SUMMARY

The described embodiments include an audio/video (A/V) hub. This A/V hub includes: an antenna; an interface circuit that, during operation, communicates with an A/V display device and content sources; and a control circuit coupled to the interface circuit. During operation, the control circuit generates first display instructions specifying a first display layout on a display in the A/V display device, where the first display layout includes first A/V content from a first content source displayed in a central window of the display and second A/V content from a second content source displayed in a tiled window of the display. Note that the tiled window may be smaller than the central window and located proximate to a periphery of the display. Then, the control circuit provides, via the interface circuit, the first display instructions, the first A/V content and the second A/V content to the A/V display device for display on the display. Moreover, the control circuit dynamically analyzes the second A/V content to identify a type of change in the second A/V content. Next, the control circuit generates second display instructions specifying a second display layout on the display based on the analysis, where the second display layout includes the second A/V content displayed in the central window. Furthermore, the control circuit provides, via the interface circuit, the second display instructions and the second A/V content to the A/V display device for display on the display.

In some embodiments, the second display layout includes the first A/V content displayed in the tiled window and, when providing the second display instructions and the second A/V content, the control circuit provides, via the interface circuit, the first A/V content to the A/V display device for display on the display. Thus, in some embodiments, when the type of change is detected, the second A/V content and the first A/V content reverse positions in the central window and the tiled window.

Note that the type of change may include an increase in an audio volume in the second A/V content exceeding a threshold value. For example, the audio volume may be associated with: crowd noise at an entertainment event (such as a concert or a sporting event), a child crying, and/or a door bell. Alternatively or additionally, the type of change may include: motion in an environment and/or a hazardous condition. In some embodiments, the control circuit analyzes the second A/V content to identify one or more individuals, and the type of change includes the presence of an unidentified or an unauthorized individual.

Moreover, the second A/V content may be received using a Transmission Control Protocol/Internet Protocol (TCP/IP) communication protocol. For example, the second A/V content may be associated with an indoor or an outdoor security camera (and, more generally, a monitoring device that includes an imaging sensor). During operation, the control circuit may transform the second A/V content to a different communication protocol prior to providing the second A/V content to the A/V display device.

Furthermore, during operation, the control circuit may determine the first display instructions and the second display instructions based on a format of the display.

Additionally, at least one of the first A/V content and the second A/V content may include high-definition multimedia-interface (HDMI) content, and the second A/V content may be provided to the A/V display device as frames with the second A/V content are received from the second content source, so that the second A/V content is displayed on a display in the A/V display device concurrently with the first content.

In some embodiments, the control circuit includes a processor and a memory, coupled to the processor, which stores a program module. During operation, the program module is executed by the processor. This program module may include instructions for at least some of the operations performed by the control circuit.

Moreover, in some embodiments, the second A/V content is not initially displayed in the tiled window. Instead, the second A/V content is kept in a virtual display stack of the control circuit and is dynamically analyzed. When the type of change is detected, the control circuit generates third display instructions specifying a display layout on the display based on the analysis, where the third display layout includes the second A/V content displayed in the central window or the tiled window. Furthermore, the control circuit provides, via the interface circuit, the third display instructions and the second A/V content to the A/V display device for display on the display.

In some embodiments, prior to the dynamic analysis, the control circuit determines the type of change that will be identified based on: a location of the second content source, a type of the second content source, a timestamp and/or a type of the second A/V content.

Another embodiment provides a computer-program product for use with the A/V hub. This computer-program product includes instructions for at least some of the operations performed by the A/V hub.

Another embodiment provides a method for adapting displayed A/V content. This method includes at least some of the operations performed by the A/V hub.

Another embodiment provides the A/V display device.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating a system with electronic devices wirelessly communicating in accordance with an embodiment of the present disclosure.

FIG. 2 is a flow diagram illustrating a method for adapting displayed audio/video (A/V) content in accordance with an embodiment of the present disclosure.

FIG. 3 is a drawing illustrating communication among the electronic devices in FIG. 1 in accordance with an embodiment of the present disclosure.

FIG. 4 is a drawing illustrating communication among the electronic devices in FIG. 1 in accordance with an embodiment of the present disclosure.

FIG. 5 is a drawing illustrating a display in an A/V display device of FIG. 1 in accordance with an embodiment of the present disclosure.

FIG. 6 is a drawing illustrating a display in the A/V display device of FIG. 1 in accordance with an embodiment of the present disclosure.

FIG. 7 is a block diagram illustrating a state-detection circuit in one of the electronic devices of FIG. 1 in accordance with an embodiment of the present disclosure.

FIG. 8 is a flow diagram illustrating a method for detecting an electronic device in accordance with an embodiment of the present disclosure.

FIG. 9 is a block diagram illustrating one of the electronic devices of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An audio/video (A/V) hub that dynamically analyzes A/V content and modifies display of the A/V content is described. In particular, A/V hub may receive the A/V content from content sources, and may dynamically analyze the A/V content to identify a type of change in the A/V content. When the type of change is detected, the A/V hub may generate display instructions specifying a display layout of the A/V content on a display in an A/V display device, and may provide the display instructions and the A/V content to the display. For example, the A/V hub may display the A/V content in a central window of the display. This may involve swapping the A/V content with other A/V content that was previously displayed in the central window, and the other A/V content may be displayed in a tiled window (such as a tiled window that is smaller than the central window and that is located proximate to a periphery of the display). Alternatively, the A/V hub may display the A/V content in a new tiled window of the display.

By dynamically adapting the displayed A/V content (such as high-definition multimedia-interface or HDMI content) in response to detecting the type of change, the display technique may automatically and visually alert a user or viewer of the display to interesting or important information (such as changes in the information) in the A/V content. This may allow the viewer to multitask, such as allowing the viewer to watch several sporting events at the same time or to watch a movie while still ‘monitoring’ a baby camera. In particular, the display technique may allow the viewer to be differentially and visually alerted when there is a particular type of change in the A/V content. This approach may also prevent errors (such as missing the type of change in the A/V content) because monitoring the A/V content at other times (without the interesting or important information) may be time consuming and tiring. Thus, the display technique may reduce user errors, may reduce user frustration and/or may improve the user experience when using the A/V hub, the A/V display device and/or one or more content sources.

In the discussion that follows the A/V hub (which is sometimes referred to as an ‘electronic device’), a portable electronic device, the A/V display device, the one or more content sources, and/or another electronic device (such as a speaker and, more generally, a consumer-electronic device) may include radios that communicate packets or frames in accordance with one or more communication protocols, such as: an Institute of Electrical and Electronics Engineers (IEEE) 802.11 standard (which is sometimes referred to as ‘Wi-Fi®,’ from the Wi-Fi® Alliance of Austin, Tex.), Bluetooth® (from the Bluetooth Special Interest Group of Kirkland, Wash.), a cellular-telephone communication protocol, a near-field-communication standard or specification (from the NFC Forum of Wakefield, Mass.), and/or another type of wireless interface. In the discussion that follows, Wi-Fi is used as an illustrative example. For example, the cellular-telephone communication protocol may include or may be compatible with: a 2^{nd} generation of mobile telecommunication technology, a 3^{rd} generation of mobile telecommunications technology (such as a communication protocol that complies with the International Mobile Telecommunications-2000 specifications by the International Telecommunication Union of Geneva, Switzerland), a 4^{th} generation of mobile telecommunications technology (such as a communication protocol that complies with the International Mobile Telecommunications Advanced specification by the International Telecommunication Union of Geneva, Switzerland), and/or another cellular-telephone communication technique. In some embodiments, the communication protocol includes Long Term Evolution or LTE. However, a wide variety of communication protocols may be used (such as Ethernet or a power-line communication protocol). In addition, the communication may occur via a wide variety of frequency bands. Note that the portable electronic device, the A/V hub, the A/V display device, the one or more content sources, one or more speakers and/or another electronic device may communicate using infra-red communication that is compatible with an infra-red communication standard (including unidirectional or bidirectional infra-red communication).

Moreover, A/V content in following discussion may include video and associated audio (such as music, sound, dialog, etc.), video only or audio only.

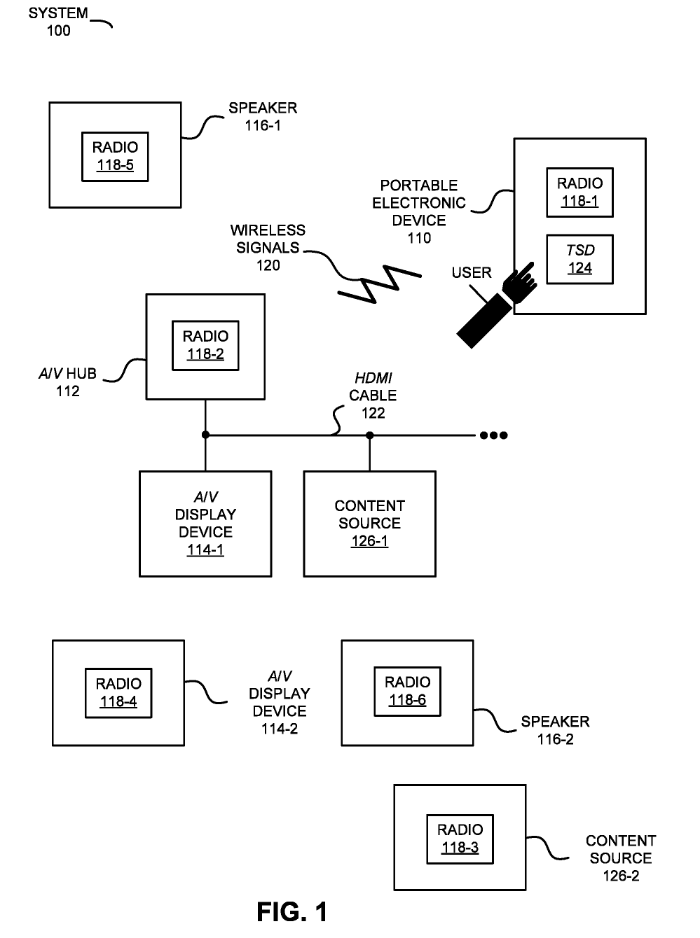

Communication among electronic devices is shown in FIG. 1, which presents a block diagram illustrating a system 100 with a portable electronic device 110 (such as a remote control or a cellular telephone), an A/V hub 112, one or more A/V display devices 114 (such as a television, a monitor, a computer and, more generally, a display associated with an electronic device), one or more speakers 116 and one or more content sources 126 (e.g., a radio receiver, a video player, a satellite receiver, an access point that provides a connection to a wired network such as the Internet, a media or a content source, a consumer-electronic device, an entertainment device, a set-top box, over-the-top content delivered over the Internet or a network without involvement of a cable, satellite or multiple-system operator, a security camera, a monitoring camera, etc.). (Note that A/V hub 112, the one or more A/V display devices 114, the one or more speakers 116 and the one or more content sources 126 are sometimes collectively referred to as ‘components’ in system 100. However, A/V hub 112, the one or more A/V display devices 114, the one or more speakers 116 and the one or more content sources 126 are sometimes referred to as ‘electronic devices.’) In particular, portable electronic device 110 and A/V hub 112 may communicate with each other using wireless communication, and A/V hub 112 and other components in system 100 (such as the one or more A/V display devices 114, the one or more speakers 116 and the one or more content sources 126) may communicate using wireless and/or wired communication. During the wireless communication, these electronic devices may wirelessly communicate while: transmitting advertising frames on wireless channels, detecting one another by scanning wireless channels, establishing connections (for example, by transmitting association requests), and/or transmitting and receiving packets or frames (which may include the association requests and/or additional information as payloads, such as user-interface information, device-state information, user-interface activity information, data, information specifying communication performance, information specifying a user interface, A/V content, etc.).

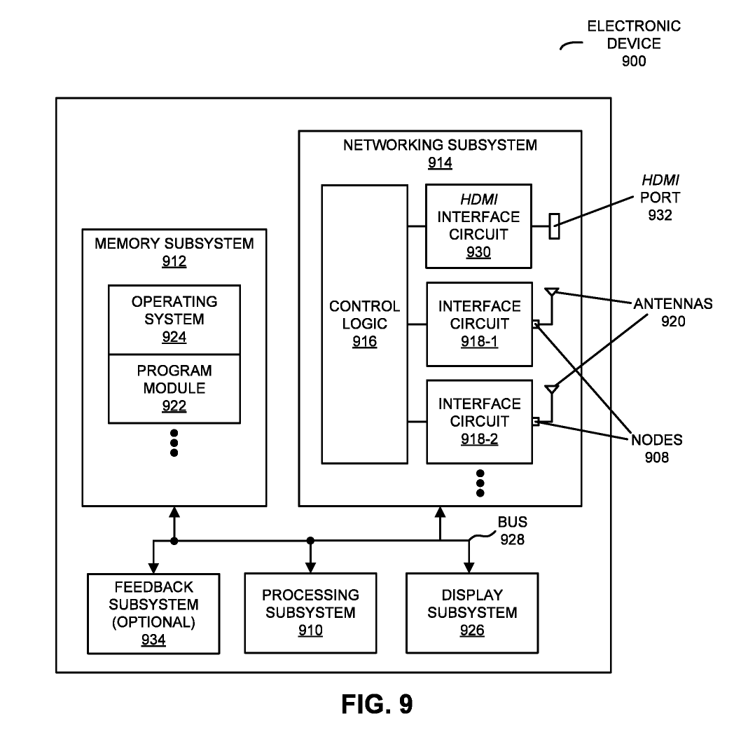

As described further below with reference to FIG. 9, portable electronic device 110, A/V hub 112, the one or more A/V display devices 114, the one or more speakers 116 and the one or more content sources 126 may include subsystems, such as: a networking subsystem, a memory subsystem and a processor subsystem. In addition, portable electronic device 110 and A/V hub 112, and optionally one or more of the one or more A/V display devices 114, the one or more speakers 116 and/or the one or more content sources 126, may include radios 118 in the networking subsystems. (Note that radios 118 may be instances of the same radio or may be different from each other.) More generally, portable electronic device 110 and A/V hub 112 (and optionally one or more of the one or more A/V display devices 114, the one or more speakers 116 and/or the one or more content sources 126) can include (or can be included within) any electronic devices with the networking subsystems that enable portable electronic device 110 and A/V hub 112 (and optionally one or more of A/V display devices 114, the one or more speakers 116 and/or the one or more content sources 126) to wirelessly communicate with each other. This wireless communication can comprise transmitting advertisements on wireless channels to enable electronic devices to make initial contact or detect each other, followed by exchanging subsequent data/management frames (such as association requests and responses) to establish a connection, configure security options (e.g., Internet Protocol Security), transmit and receive packets or frames via the connection, etc.

As can be seen in FIG. 1, wireless signals 120 (represented by a jagged line) are transmitted from radio 118-1 in portable electronic device 110. These wireless signals may be received by at least A/V hub 112. In particular, portable electronic device 110 may transmit packets (or frames). In turn, these packets may be received by a radio 118-2 in A/V hub 112. This may allow portable electronic device 110 to communicate information to A/V hub 112. While FIG. 1 illustrates portable electronic device 110 transmitting packets, note that portable electronic device 110 may also receive packets from A/V hub 112 and/or one or more other components in system 100. More generally, wireless signals may be transmitted and/or received by one or more of the components in system 100.

In the described embodiments, processing of a packet or frame in portable electronic device 110 and A/V hub 112 (and optionally one or more of the one or more A/V display devices 114, the one or more speakers 116 and/or the one or more content sources 126) includes: receiving wireless signals 120 with the packet or frame; decoding/extracting the packet or frame from received wireless signals 120 to acquire the packet or frame; and processing the packet or frame to determine information contained in the packet or frame (such as the information associated with a data stream). For example, the information from portable electronic device 110 may include user-interface activity information associated with a user interface displayed on touch-sensitive display (TSD) 124 in portable electronic device 110, which a user of portable electronic device 110 uses to control A/V hub 112, the one or more A/V display devices 114, the one or more speakers 116 and/or one of the one or more content sources 126. (In some embodiments, instead of or in additional to touch-sensitive display 124, portable electronic device 110 includes a user interface with physical knobs and/or buttons that a user can use to control A/V hub 112, the one or more A/V display devices 114, the one or more speakers 116 and/or one of the one or more content sources 126.) Alternatively, the information from A/V hub 112 may include device-state information about a current device state of one or more of A/V display devices 114, the one or more speakers 116 or one of the one or more content sources 126 (such as on, off, play, rewind, fast forward, a selected channel, selected content, a content source, etc.), or may include user-interface information for the user interface (which may be dynamically updated based on the device-state information and/or the user-interface activity information). Furthermore, the information from A/V hub 112 and/or one of the one or more content sources 126 may include audio and video (which is sometimes denoted as ‘audio/video’ or ‘A/V’) that are displayed or presented on one or more of A/V display devices 114 and/or one or more of speakers 116, as well as display instructions that specify how the audio and video are to be displayed.

However, as noted previously, the audio and video may be communicated between components in system 100 via wired communication. Therefore, as shown in FIG. 1, there may be a wired cable or link, such as a high-definition multimedia-interface (HDMI) cable 122, between A/V hub 112 and A/V display device 114-1. While the audio and/or video may be included in or associated with HDMI content, in other embodiments the audio content may be included in or associated with A/V content that is compatible with another format or standard is used in the embodiments of the disclosed communication technique. For example, the A/V content may include or may be compatible with: H.264, MPEG-2, a QuickTime video format, MPEG-4, MP4, and/or TCP/IP. Moreover, the video mode of the A/V content may be 720p, 1080i, 1080p, 1440p, 2000, 2160p, 2540p, 4000p and/or 4320p. In some embodiments, at least one of content sources 126 includes a security or monitoring camera that communicates sound and images and, more generally, A/V content using a Transmission Control Protocol/Internet Protocol (TCP/IP) communication protocol.)

Note that A/V hub 112 may determine display instructions (with a display layout) for the A/V content based on a format of a display in one of A/V display devices 114, such as A/V display device 114-1. Alternatively, A/V hub 112 can use predetermined display instructions or A/V hub 112 can modify or transform the A/V content based on the display layout so that the modified or transformed A/V content has an appropriate format for display on the display. Moreover, the display instructions may specify information to be displayed on the display in A/V display device 114-1, including where A/V content is displayed (such as in a central or largest window, in a tiled window, etc.). Consequently, the information to be displayed (i.e., an instance of the display instructions) may be based on a format of the display, such as: a display size, display resolution, display aspect ratio, display contrast ratio, a display type, etc. Furthermore, note that when A/V hub 112 receives the A/V content from one of content sources 126, A/V hub 112 may provide the A/V content and display instructions to A/V display device 114-1 as frames with the A/V content are received from one of content sources 126 (e.g., in real time), so that the A/V content is displayed on the display in A/V display device 114-1. For example, A/V hub 112 may collect the A/V content in a buffer until a frame is received, and then A/V hub 112 may provide the complete frame to A/V display device 114-1. Alternatively, A/V hub 112 may provide packets with portions of a frame to A/V display device 114-1 as they are received. In some embodiments, the display instructions may be provided to A/V display device 114-1 differentially (such as when the display instructions change), regularly or periodically (such as in one of every N packets or in a packet in each frame) or in each packet.

Moreover, note that the communication between portable electronic device 110 and A/V hub 112 (and optionally one or more of the one or more A/V display devices 114, the one or more speakers 116 and/or the one or more content sources 126) may be characterized by a variety of performance metrics, such as: a data rate, a data rate discounting radio protocol overhead (which is sometimes referred to as a ‘throughput’), an error rate (such as a packet error rate, or a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a channel or link), and/or a ratio of an actual data rate to an estimated data rate (which is sometimes referred to as ‘utilization’). Moreover, the performance during the communication associated with different channels may be monitored individually or jointly (e.g., to identify dropped packets).

The communication between portable electronic device 110 and A/V hub 112 (and optionally one or more of the one or more A/V display devices 114, the one or more speakers 116 and/or the one or more content sources 126) in FIG. 1 may involve one or more independent, concurrent data streams in different wireless channels (or even different communication protocols, such as different Wi-Fi communication protocols) in one or more connections or links, which may be communicated using multiple radios. Note that the one or more connections or links may each have a separate or different identifier (such as a different service set identifier) on a wireless network in system 100 (which may be a proprietary network or a public network). Moreover, the one or more concurrent data streams may, on a dynamic or packet-by-packet basis, be partially or completely redundant to improve or maintain the performance metrics even when there are transient changes (such as interference, changes in the amount of information that needs to be communicated, movement of portable electronic device 110, etc.), and to facilitate services (while remaining compatible with the communication protocol, e.g., a Wi-Fi communication protocol) such as: channel calibration, determining of one or more performance metrics, performing quality-of-service characterization without disrupting the communication (such as performing channel estimation, determining link quality, performing channel calibration and/or performing spectral analysis associated with at least one channel), seamless handoff between different wireless channels, coordinated communication between components, etc. These features may reduce the number of packets that are resent, and, thus, may decrease the latency and avoid disruption of the communication and may enhance the experience of one or more users that are viewing A/V content on the one or more A/V display devices 114 and/or listening to audio output by one or more of speakers 116.

As noted previously, a user may control A/V hub 112, one or more of the one or more A/V display devices 114, one or more of the one or more speakers 116 and/or one of the one or more content sources 126 via the user interface displayed on touch-sensitive display 124 on portable electronic device. In particular, at a given time, the user interface may include one or more virtual icons that allow the user to activate, deactivate or change functionality or capabilities of A/V hub 112, one or more of A/V display devices 114, one or more of speakers 116 and/or one or more of content sources 126. For example, a given virtual icon in the user interface may have an associated strike area on a surface of touch-sensitive display 124. If the user makes and then breaks contact with the surface (e.g., using one or more fingers or digits, or using a stylus) within the strike area, portable electronic device 110 (such as a processor executing a program module) may receive user-interface activity information indicating activation of this command or instruction from a touch-screen input/output (I/O) controller, which is coupled to touch-sensitive display 124. (Alternatively, touch-sensitive display 124 may be responsive to pressure. In these embodiments, the user may maintain contact with touch-sensitive display 124 with an average contact pressure that is usually less than a threshold value, such as 10-20 kPa, and may activate a given virtual icon by increase the average contact pressure with touch-sensitive display 124 above the threshold value.) In response, the program module may instruct an interface circuit in portable electronic device 110 to wirelessly communicate the user-interface activity information indicating the command or instruction to A/V hub 112, and A/V hub 112 may communicate the command or the instruction to the target component in system 100 (such as A/V display device 114-1). This instruction or command may result in A/V display device 114-1 turning on or off, displaying A/V content from a particular content source, performing a trick mode of operation (such as fast forward, reverse, fast reverse or skip), etc. For example, A/V hub 112 may request the A/V content from content source 126-1, and then may provide the A/V content to along with display instructions to A/V display device 114-1, so that A/V display device 114-1 displays the A/V content. Alternatively or additionally, A/V hub 112 may provide audio content associated with video content from content source 126-1 to one or more of speakers 116.

One problem with using existing remote controls to control the operation of another component or electronic device is that the remote control does not receive any feedback from the electronic device. For example, many existing remote controls use infra-red communication. However, typically existing infra-red communication protocols are unidirectional or one-way communication, i.e., from a remote control to the electronic device. Consequently, the remote control usually does not have any knowledge of the effects of the commands or instructions that are communicated to the electronic device. In particular, the remote control is typically unaware of a current state of the electronic device, such as whether the electronic device is in: a power-on state, a power-off state, a playback state, a trick-mode state (such as fast forward, fast reverse, or skip), a pause state, a standby (reduced-power) state, a record state, a state in which A/V content associated with a given content source (such as cable television, a satellite network, a web page on the Internet, etc.) is received or provided, and/or another state. (Note that one or more of the states may be nested or concurrent with each other, such as the power-on state and the playback state.) Similarly, while some existing remote controls are capable of bidirectional or two-way communication, these remote controls do not receive feedback from the electronic device and, thus, are unaware of the current state of the electronic device. By operating blindly in this way, existing remote control are unable to leverage knowledge of the current state of the electronic device to improve the user experience.

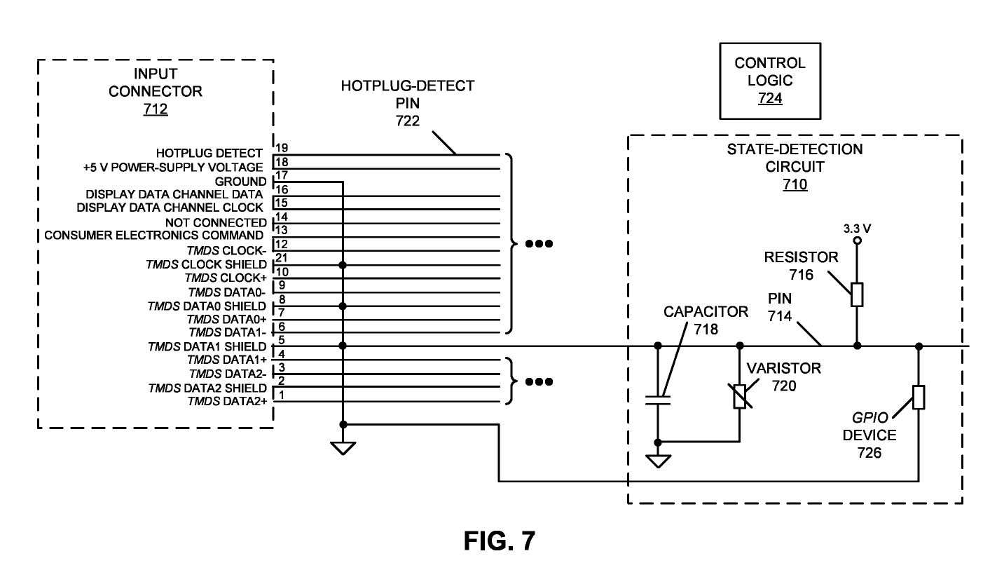

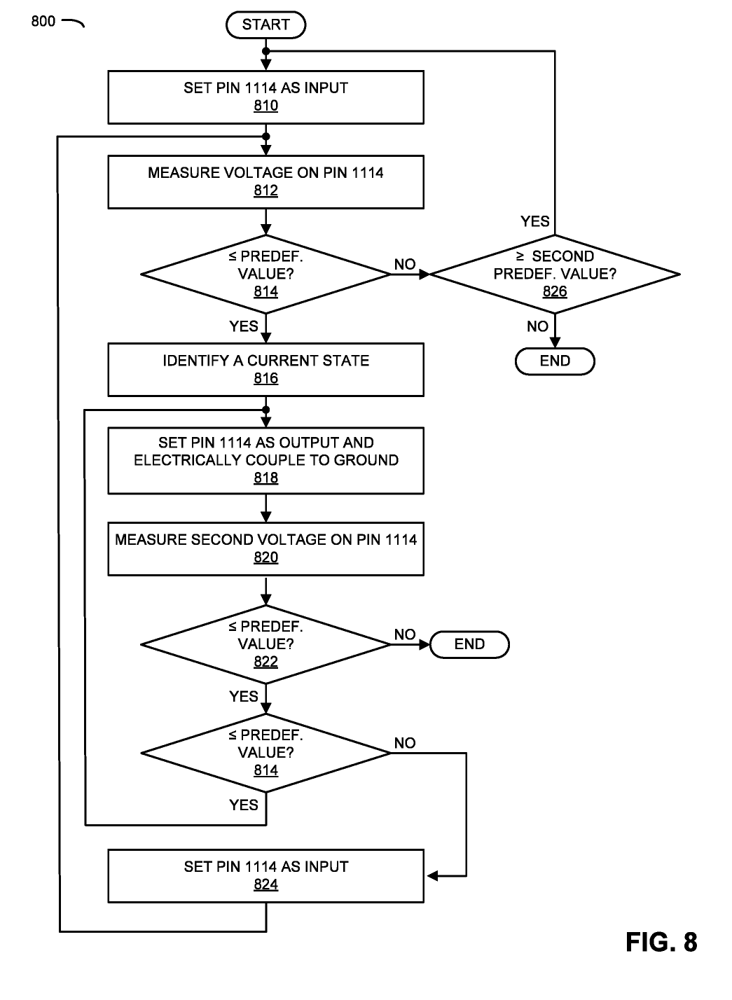

This problem is addressed in system 100. In particular, as described further below with reference to FIGS. 7 and 8, A/V hub 112 may determine the current state of one or more of the components in system 100, such as the current state of A/V display device 114-1, one of the one or more speakers 116 and/or one of the one or more content sources 126. This device-state information may be determined by A/V hub 112 using hardware and/or software, and A/V hub 112 may determine the device-state information even for legacy electronic devices that are only capable of receiving commands or instructions (i.e., that are only capable of unidirectional communication). For example, as described further below with reference to FIGS. 7 and 8, whether or not a given component or electronic device in system 100 is electrically coupled to A/V hub 112 may be determined using a state-detection circuit that detects whether there is electrical coupling between the electronic device and an input connector to A/V hub 112 (such as an HDMI connector or port that can be electrically coupled to HDMI cable 122). If the electrical coupling is detected, the type of the given electronic device (such as a television, a DVD player, a satellite receiver, etc.) and/or the manufacturer or provider of the given electronic device may be determined by A/V hub 112 by providing a series of commands or instructions to the given electronic device (e.g., such as commands or instructions that are specific to a particular type of electronic device, specific to a particular manufacturer, and/or consumer-electronics-control commands in the HDMI standard or specification), and then monitoring, as a function of time, changes in a data stream (as indicated by the number of packets or frames and/or the payloads in the packets or frames) to and/or from the given electronic device to see if there was a response to a particular command or instruction. Moreover, the state-detection circuit may determine whether the given electronic device is in the power-on state or the power-off state by monitoring a voltage, a current and/or an impedance on, through or associated with one or more pins in the input connector. Alternatively or additionally, A/V hub 112 may determine whether the given electronic device is in the power-on state or the power-off state by monitoring, as a function of time, the data stream (as indicated by the number of packets or frames and/or the payloads in the packets or frames) to and/or from the given electronic device. Similarly, A/V hub 112 may determine the current state of the given electronic device, such as whether the given electronic device responded to a command or instruction that was provided to the given electronic device by A/V hub 112, by monitoring, as a function of time, changes in the data stream (as indicated by the number of packets or frames and/or the payloads in the packets or frames) to and/or from the given electronic device. Thus, the device-state information for the given electronic device determined by A/V hub 112 may include: presence or absence information (such as whether there is electrical coupling or a wireless connection with the given electronic device), identity information (such as the type of the given electronic device and/or the manufacturer of the given electronic device) and/or the current state.

Using the device-state information A/V hub 112 and/or portable electronic device 110 may dynamically adapt the user interface displayed on touch-sensitive display 124 on portable electronic device 110. For example, A/V hub 112 may provide, via radio 118-2, device-state information to portable electronic device 110 specifying a current state of the given electronic device. (Thus, this feedback technique may include bidirectional or two-way communication between A/V hub 112 and portable electronic device 110.) After radio 118-1 receives the device-state information, portable electronic device 110 (such as a program module executed in an environment, e.g., an operating system, in portable electronic device 110) may generate a user interface that includes one or more virtual command icons associated with the current state and one or more related states of the given electronic device. (Alternatively, portable electronic device 110 may selected a predefined or predetermined user interface.) Note that the one or more related states may be related to the current state in a state diagram (which may be stored in memory in portable electronic device 110) by corresponding operations that transition the given electronic device from the current state to the one or more related states. Then, portable electronic device 110 may display the user interface on touch-sensitive display 124.

In some embodiments, A/V hub 112 provides information specifying the type of the given electronic device, the manufacturer of the given electronic device, and/or context information that specifies a context of content (such as A/V content or information specifying a content provider) displayed on the given electronic device (such as on a display in A/V display device 114-1). For example, the context may include a type of the A/V content (such as sports, television, a movie, etc.), a location in the A/V content (such as a timestamp, an identifier of a sub-section in the content and/or a proximity to a beginning or an end of the A/V content), etc. In these embodiments, the one or more virtual command icons (and, thus, the user interface) may be based on the type of the given electronic device, the manufacturer and/or the context. Thus, only virtual command icons that are relevant to the given electronic device, the manufacturer and/or the context may be included in the user interface.

Moreover, when the user activates one of the virtual command icons in the user interface, the touch-screen I/O controller in portable electronic device 110 may provide user-interface activity information specifying activation of a virtual command icon in the one or more virtual command icons, where the activation of the virtual command icon specifies a transition of the given electronic device from the current state to a new current state in the state diagram. As noted previously, the activation of the virtual command icon may involve a user of portable electronic device 110 contacting touch-sensitive display 124 within a strike area of the virtual command icon and then releasing the contact. In response to receiving the user-interface activity information, portable electronic device 110 may: request the A/V content associated with the virtual command icon, modify the user interface to change the one or more virtual command icons based on the new current state; and display the modified user interface on touch-sensitive display 124. Note that portable electronic device 110 may wait to change the one or more virtual command icons until the device-state information received from A/V hub 112 indicates that the given electronic device has transitioned to the new current state in response to a command or an instruction associated with the activation of the one of the virtual command icons. Thus, portable electronic device 110 may repeatedly perform the generating and the displaying operations so that the user interface is dynamically updated as the current state changes.

Alternatively or additionally, instead of portable electronic device 110 generating the user interface, A/V hub 112 may generate user-interface information that specifies the user interface (or instructions specifying objects or graphical information in the user interface) based on the one or more related states in the state diagram (which may be stored in memory in A/V hub 112) and one or more of: the device-state information, the type of the given electronic device, the manufacturer of the given electronic device, the context, user-interface activity information specifying activation (by the user) of one of the virtual command icons in the user interface (which may be received, via radio 118-2, from portable electronic device 110), and/or a display format in portable electronic device 110. (Alternatively, instead of generating the user interface, A/V hub 112 may select a predefined or predetermined user-interface information.) Then, A/V hub 112 may provide, via radios 118, the user-interface information to portable electronic device 110 for display on touch-sensitive display 124.

In this way, the user interface may be dynamically updated as the components in system 100 respond to commands or instructions received from portable electronic device 110 and/or A/V hub 112, so that the currently relevant one or more virtual icons are included in the user interface. This capability may simplify the user interface and make it easier for the user to navigate through and/or use the user interface.

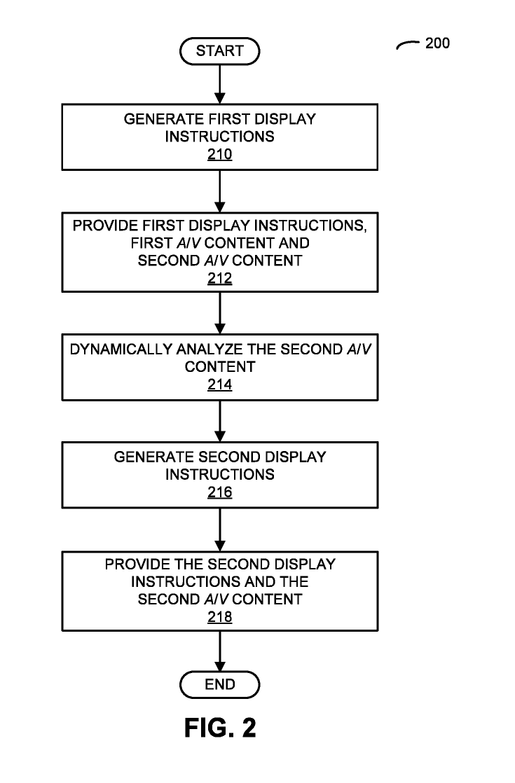

Moreover, as described further below with reference to FIGS. 2-4, changes in the A/V content (such as types or classifications of the changes), as well as the device-state information (such as when a given electronic device is turned on, is recording or has acquired the A/V content, etc.) and/or a type of the given electronic device (e.g., a security or nanny camera, etc.), may be used by A/V hub 112 to dynamically adapt or change how the A/V content is displayed on one or more of A/V display devices 114, e.g., on a display in A/V display device 114-1. In particular, in response to receiving a user selection of content source 126-1 (or user-interface activity information that specifies the user selection) based on activation of one or more command features in portable electronic device 110 that are associated with content source 126-1 (such as a single virtual command icon in a user interface displayed on portable electronic device 110), A/V hub 112 may provide a request for first A/V content to content source 126-1. When A/V hub 112 receives the first A/V content from content source 126-1, A/V hub 112 may provide the first A/V content and display instructions to A/V display device 114-1 as frames with the first A/V content are received from content source 126-1 (e.g., in real time), so that the first A/V content is displayed on the display in A/V display device 114-1.

Furthermore, in response to receiving a user selection of content source 126-2 (or user-interface activity information that specifies the user selection) based on activation of one or more command features in portable electronic device 110 that are associated with content source 126-2 (such as a single virtual command icon in a user interface displayed on portable electronic device 110), A/V hub 112 may provide a request for second A/V content to content source 126-2. When A/V hub 112 receives the second A/V content from content source 126-2, A/V hub 112 may provide the second A/V content and display instructions to A/V display device 114-1 as frames with the second A/V content are received from content source 126-2 (e.g., in real time), so that the second A/V content is displayed on the display in A/V display device 114-1. In some embodiments, the second A/V content is received using a Transmission Control Protocol/Internet Protocol (TCP/IP) communication protocol. For example, the second A/V content may be associated with an indoor or an outdoor security camera (and, more generally, a monitoring device that includes an imaging sensor). Consequently, prior to providing the second A/V content and display instructions to A/V display device 114-1, A/V hub 112 may transform the second A/V content to a different communication protocol (such as HDMI).

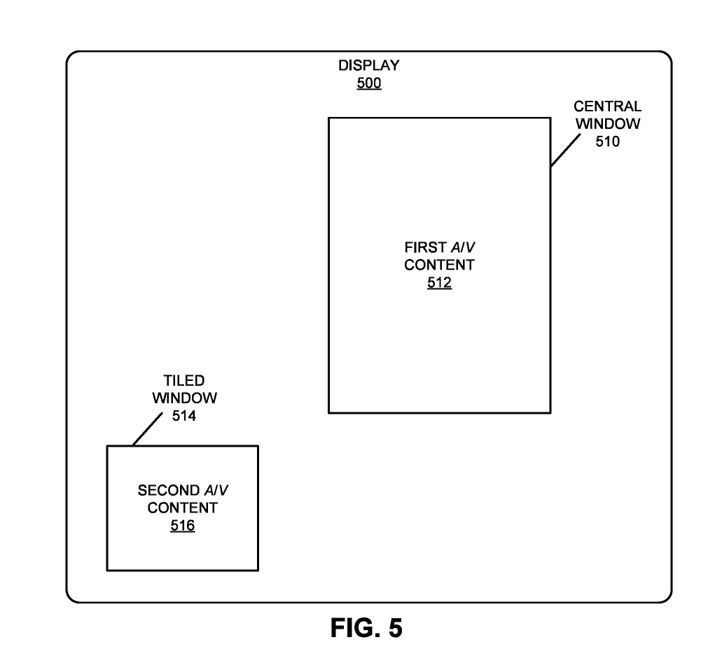

Note that the first A/V content from content source 126-1 and the second A/V content from content source 126-2 may be displayed concurrently on the display in A/V display device 114-1. (This may involve addressing security issues associated with the concurrent display of HDMI content in the tiled window and the central window, such as eliminating a risk of hacking, including attempts at intentional communication of malicious content, e.g., malicious software, malware or a so-called ‘virus’) For example, as described further below with reference to FIG. 5, the first A/V content from content source 126-1 may be displayed in a central window on the display (which, in general, is larger than other windows on the display, and which may or may not be located in a center of the display) and the second A/V content from content source 126-2 may be displayed in a tiled window on the display (such as a tiled window that is smaller than the central window and that is located at or proximate to a periphery or edge of the display). (Thus, the display instructions may specify the positions or locations in the display where the first A/V content and the second A/V content are displayed.) In an exemplary embodiment, the first A/V content from content source 126-1 includes entertainment (such as video of a sporting event) and the second A/V content from content source 126-2 includes additional entertainment (such as video of another sporting event) or audio and/or video monitoring of an environment (such as a feed from a security camera or a monitoring camera, e.g., a ‘nanny’ or ‘baby’ camera). In the display technique, a ‘tiled window’ may include a window in at least a portion of the display area that does not overlap another window, but that presents A/V content (such HDMI content) overlaid on a background of the window. (Alternatively or additionally, A/V content may be displayed in a cascaded or overlapped window that at least partially overlaps or that is partially overlapped by another window.) Thus, the display technique may allow A/V content to be presented in a tiled window in real time (such as when frames with A/V content are received from content source 126-1 or 126-2). Moreover, the display instructions may specify information to be displayed on the display in A/V display device 114-1, including where A/V content is displayed (such as in the central window, in a tiled window, etc.). Consequently, the information to be displayed (i.e., an instance of the display instructions) may be based on a format of the display, such as: a display size, display resolution, display aspect ratio, display contrast ratio, a display type, etc.

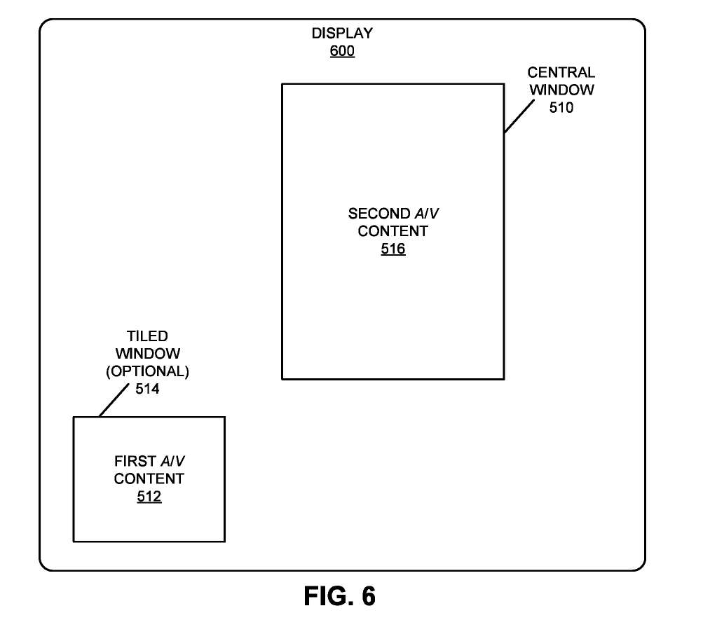

Additionally, A/V hub 112 may dynamically analyze the second A/V content from content source 126-2 to (e.g., on a frame-by-frame basis) identify a type of change. For example, the second A/V content may be analyzed (such as continuously, periodically, after a time interval, on an event basis, etc.) to determine when a commercial is playing or has ended. (Thus, detection or identification of the type of change may be based on content and/or context awareness.) As described further below with reference to FIG. 6, when the type of change is detected A/V hub 112 may generate revised display instructions specifying a new display layout on the display. This display layout may include the second A/V content displayed in the central window. Then, A/V hub 112 may provide the revised display instructions and the second A/V content to A/V display device 114-1 for display on the display. In some embodiments, the revised display instructions reverse or switch the display of the first A/V content and the second A/V content, so the second A/V content is displayed in the central window and the first A/V content is displayed in the tiled window. (However, in some embodiments, only the second A/V content is displayed in the central window when the type of change is detected. Thus, in some embodiments, when the type of change is identified, the display instructions may indicate that the second A/V content displayed in the central window and the display of the tiled window is discontinued.)

For example, the type of change may include an increase in an audio volume in the second A/V content exceeding a threshold value, e.g., 30-110 dBA (such as crowd noise or cheering at an entertainment event, e.g., a concert or a sporting event, a child crying, and/or a door bell). Alternatively or additionally, the type of change may include: motion in an environment (such as a motion vector between two frames exceeding an average noise amplitude in one or more of the frames) and/or a hazardous condition (such as when a fire alarm, a carbon-monoxide detector, a motion detector and/or a security alarm is activated). In some embodiments, A/V hub 112 analyzes the second A/V content to identify one or more individuals (such as using a face-recognition technique or another biometric-identification technique), and the type of change includes the presence of an unidentified or an unauthorized individual. In the display technique, the user may use the user interface displayed on portable electronic device 110 (such as one or more virtual command icons) to specify or select one or more types of change that A/V hub 112 looks for when dynamically analyzing the second A/V content.

Note that the second A/V content may be displayed in the central window until another user selection is received from portable electronic device 110 (or user-interface activity information that specifies the other user selection) based on activation of one or more command features in portable electronic device 110 that is associated with content source 126-2 (such as a single virtual command icon in a user interface displayed on portable electronic device 110). For example, when the second A/V content is displayed in the central window, the virtual command icons displayed in the user interface on portable electronic device 110 may change to provide the user with options for how to respond to the detected change. In particular, the virtual command icons may include options such as: revert to the original display instructions (i.e., with the first A/V content in the central window and the second A/V content in the tiled window), dial emergency services (such as 911), pausing display of the second A/V content, start recording the second A/V content, etc. Alternatively, the second A/V content may be displayed in the central window for a predefined time duration (such as 10 s or 30 s) or until the type of change is no longer detected in the second A/V content.

While the preceding discussion illustrated the display of the second A/V content in the tiled window and then in the central window, in other embodiments the second A/V content is not initially displayed in the tiled window. Instead, the second A/V content may be kept in a virtual display stack of A/V hub 112 and may be dynamically analyzed. When the type of change is detected, A/V hub 112 may generate the revised display instructions specifying a new display layout on the display, where the revised display layout includes the second A/V content displayed in the central window or the tiled window. Then, A/V hub 112 may provide the second A/V content and the revised display instructions to A/V display device 114-1 for display on the display. Note that the A/V content may not have been previously displayed, i.e., the tiled window may be a new window on the display. Thus, the display instructions may specify a new tiled window to be created in the display based on detection of the type of change without requiring further action or additional operations be performed by the user.

Moreover, while the preceding discussion illustrated the display information being revised based on the analysis of the second A/V content (such as based on the detection of the type of change), in other embodiments the display information is revised based on: device-state information (such as a change in the state of one or more components in system 100) and/or analysis of the first A/V content (e.g., if the same of a different type of change is detected in the first A/V content, revising the display instructions may be delayed, such as by 10 s or until the type of change is no longer detected in the first A/V content).

In these ways, the display technique may allow automated, visual alerts to the user of changes in A/V content, such as interesting or important information. Moreover, the display technique may facilitate improved monitoring of the first A/V content and the second A/V content with less time, less effort and fewer errors or mistakes (such as missing the type of change). Consequently, the display technique may reduce user frustration and/or may improve the user experience when using portable electronic device 110, A/V hub 112, one or more of A/V display devices 114 and/or one or more content sources 126.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames. While portable electronic device 110 and A/V hub 112 are illustrated with a single instance of radios 118, in other embodiments portable electronic device 110 and A/V hub 112 (and optionally one or more of A/V display device 114-1, one or more of speakers 116 and/or the one or more content sources 126) may include multiple radios.

We now describe embodiments of a display technique. FIG. 2 presents a flow diagram illustrating a method 200 for providing adapting displayed A/V content, which may be performed by an A/V hub, such as A/V hub 112 (FIG. 1). During operation, the A/V hub (such as a control mechanism, a control circuit or control logic, e.g., a processor executing a program module and/or or a circuit) generates first display instructions (operation 210) specifying a first display layout on a display in an A/V display device, where the first display layout includes first A/V content from a first content source displayed in a central window of the display and second A/V content from a second content source displayed in a tiled window of the display. Note that the tiled window may be smaller than the central window and may be located proximate to a periphery of the display.

Then, the A/V hub provides, via an interface circuit in the A/V hub, the first display instructions, the first A/V content and the second A/V content (operation 212) to the A/V display device for display on the display.

Moreover, the A/V hub dynamically analyzes the second A/V content (operation 214) to identify a type of change in the second A/V content. This dynamic analysis may occur: continuously, periodically (such as every 10 ms, 50 ms, 500 ms, 1 s, 10 s, 30 s, etc.), every frame, every Nth frame (such as every other frame, every third frame, every fourth frame, etc.), at random times within a time interval (such as 30 s or 1 min), when an event occurs (such as when a trigger signal or indication is received, e.g., from the second content source), etc. In addition, the dynamic analysis may involve: detecting motion between frames, determining a change in the histogram of pixel intensities, comparing audio volume to a predefined threshold or a historical baseline of the audio volume (such as the average audio volume in the last 10 or 30 s, so the threshold may be dynamic or time varying), filtering and comparing the audio volume within a band of frequencies (such as 10-200 Hz, 100-2000 Hz, etc.) to a predefined threshold or a historical baseline of the audio volume in the band of frequencies, computing a Fourier transform of the A/V content (and, more generally, performing another type of transformation on the A/V content), identifying individuals (e.g., based on audio analysis of their voice, their behaviors relative to stored historical behaviors, face-recognition analysis, etc.), etc. In some embodiments, the analysis includes the use of one or more predetermined classifiers (such as a supervised-learning technique) or a computational neural network, which analyze the A/V content for the presence of one or more features.

Note that the type of change (or feature) may be predefined and/or may be pre-specified (such as by a user of the A/V hub), and the A/V hub may access information specifying the type of change, which may be stored in memory, prior to dynamic analysis (operation 214). Alternatively, in some embodiments the A/V hub determines the type of change to look for (i.e., the type of change may not be pre-specified, instead it may be dynamically determined by the A/V hub). For example, the A/V hub may determine the type of change based on: a location of the second content source (such as in a baby's room, in which case the type of event may be motion or a baby crying), a time of day (such as night time, in which case the type of event may be the presence may be the presence of any individual near a building or home, or day time, in which case the type of event may be the presence of an identified or an unidentified individual near an entrance to a building or home), a day of the week (such as a weekday, in which case the type of event may be the presence of an identified or an unidentified individual near an entrance to a building or home), a type of A/V content (such as a sporting event, in which case the type of event may be crowd noise that indicates something interesting may have or may be occurring), a sequence of events (such detecting the sound of a fire alarm followed by the detection of smoke or heat, detecting the sound of burglar alarm followed by detecting motion or the presence of an identified or an unidentified individual in an environment, e.g., a room, detecting a loud noise followed by screaming or crying, or detecting an indication of a potentially hazardous condition followed by a subsequent indication that indicates the hazardous condition is becoming more severe or that individuals may be in danger), a type of the second content source, etc.

Furthermore, the A/V hub generates second display instructions (operation 216) specifying a second display layout on the display based on the analysis (such as when the type of change is detected), where the second display layout includes the second A/V content displayed in the central window. Additionally, the A/V hub provides, via the interface circuit, the second display instructions and the second A/V content (operation 218) to the A/V display device for display on the display. In some embodiments, the second display layout includes the first A/V content displayed in the tiled window (i.e., the original positions of the first A/V content and the second A/V content in the central window and the tiled window are reversed), and, when providing the second display instructions and the second A/V content, the A/V hub provides, via the interface circuit, the first A/V content to the A/V display device for display on the display.

In some embodiments, prior to providing the second A/V content in operations 212 and 218, the A/V hub optionally transforms the second A/V content from an initial format that is compatible with an initial communication protocol to a different communication protocol. For example, the A/V hub may transform or convert the second A/V content from an initial format that is compatible with a TCP/IP communication protocol to a format that is compatible with HDMI. Moreover, note that the A/V hub may determine the first display instructions and the second display instructions based on a format of the display.

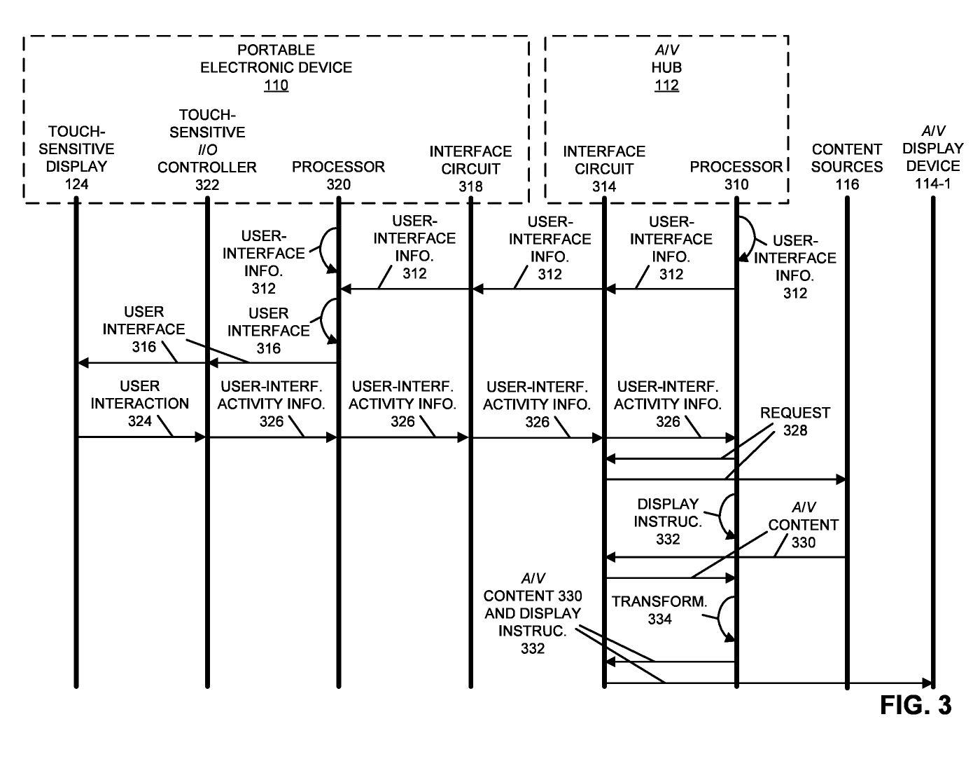

FIG. 3 is a drawing illustrating communication among portable electronic device 110, A/V hub 112, A/V display device 114-1 and content sources 126. In particular, processor 310 may optionally generate user-interface information 312 that specifies a user interface that includes one or more virtual command icons, including a virtual command icon, which are associated with content sources 126. Then, processor 310 may optionally provide, via interface circuit 314, user-interface information 312 to portable electronic device 110. After receiving user-interface information 312, portable electronic device 110 may optionally display associated user interface 316 on a touch-sensitive display (such as touch-sensitive display 124 in FIG. 1) in portable electronic device 110. However, in other embodiments user-interface information 312 is optionally generated by portable electronic device 110.

For example, interface circuit 318 in portable electronic device 110 may receive user-interface information 312, which is then provided to processor 320. Alternatively, processor 320 may generate user-interface information 312. Then, based on user-interface information 312, processor 320 may provide information specifying user interface 316 to touch-sensitive input/output (I/O) controller 322, which provides the information specifying user interface 316 to touch-sensitive display 124.

Moreover, touch-sensitive display 124 may provide information specifying user interaction 324 to touch-sensitive I/O controller 322. In turn, touch-sensitive I/O controller 322 may interpret the information specifying user interaction 324 to determine user-interface activity information 326. For example, user-interface activity information 326 may specify user selection of one of content sources 126, such as user activation of the virtual command icon associated with the one of content sources 126. Touch-sensitive I/O controller 322 may provide user-interface activity information 326 to processor 320, which may provide user-interface activity information 326 to interface circuit 318.

Next, portable electronic device 110 (e.g., via interface circuit 318) may provide user-interface activity information 326 to A/V hub 112. After receiving user-interface activity information 326, interface circuit 314 may provide user-interface activity information 326 to processor 310. In response, processor 310 may instruct interface circuit 314 to provide request 328 for A/V content 330 (such as the second A/V content) to the one of content sources 126. In addition, processor 310 may optionally determine display instructions 332 based on a format of a display in A/V display device 114-1. Alternatively, display instructions 332 may be predetermined or predefined.

After receiving request 328, the one of content sources 126 may provide A/V content 330 to A/V hub 112. Next, interface circuit 314 may optionally provide A/V content 330, which may optionally convert or transform 334 A/V content 330 from one format to another, such as from a format compatible with a TCP/IP communication protocol to a format compatible with a different communication protocol, such as HDML Moreover, interface circuit 314 may provide A/V content 330 and/or display instructions 332 (which may be provide differentially when there or changes or regularly, such in each packet or in one of every N packets) to A/V display device 114-1 as frames with A/V content 330 are received from the one of content sources 126, so that A/V content 330 is displayed on the display in A/V display device 114-1. (Alternatively, in some embodiments interface circuit 314 provides A/V content 330 to processor 310, which instructs interface circuit 314 to provide A/V content 330 and display instructions 332 to A/V display device 114-1 as frames with A/V content 330 are received from the one of content sources 126.)

Note that display instructions 332 may specify a display layout in which A/V content 330 is displayed in a tiled window on the display while additional A/V content (such as the first A/V content) from another of content sources 126 is displayed on the display in a central window. For example, A/V hub 112 may optionally: receives, via interface circuit 314, the additional A/V content from the other of content sources 126; and provides, via interface circuit 314, the additional A/V content to A/V display device 114-1, so that additional A/V content is displayed on the display. Moreover, processor 310 may optionally determine additional display instructions that specify how the additional A/V content is to be displayed on the display based on a format of the display. Furthermore, interface circuit 314 may optionally provide the additional display instructions to A/V display device 114-1.

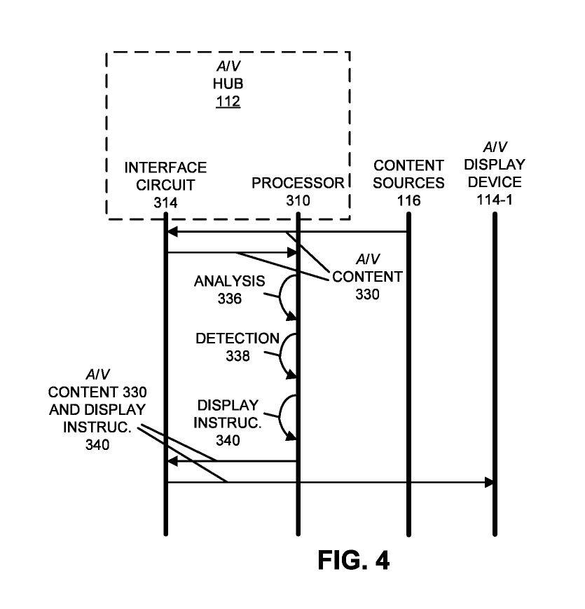

As shown in FIG. 4, which is a drawing illustrating communication among A/V hub 112, A/V display device 114-1 and content sources 126, processor 310 may dynamically analyze 336 A/V content 330. When a type of change is detected 338, processor 310 may optionally determine display instructions 340 based on a format of a display in A/V display device 114-1. These display instructions may specify a display layout on the display based on analysis 336. In particular, in the display layout, A/V content 330 may be displayed in the central window. In some embodiments, the additional A/V content from the other of content sources 126 is displayed on the display in the tiled window.

While FIGS. 3 and 4 illustrated A/V content 330 initially displayed in the tiled window, in so embodiments A/V content 330 is not initially displayed. Instead, A/V content 330 may be displayed when the type of change is detected 338. Alternatively or additionally, in some embodiments instead of the user selecting one of the content sources 126 to provide A/V content 330 (e.g., via the user interface displayed on portable electronic device 110), in other embodiments A/V content 330 is requested by A/V hub 112 based on device-state information (such as when the one of the content sources 126 is turned on, is recording A/V content 330 or has acquired A/V content 330). In response, the one of the content sources 126 may provide A/V content 330, and A/V hub 112 may instruct A/V display device 114-1 to display A/V content 330 when the type of change is detected 338.

In an exemplary embodiment, the second A/V content is associated with a security camera (which is sometimes referred to as a ‘nanny camera’) located in a baby's room, and the second A/V content is provided to the A/V hub using a TCP/IP communication protocol. A user may watch first A/V content (such as a sporting event in HDMI format) on an A/V display device (such as a television) in a central window. Concurrently, the user may keep track on the baby's room by having the second A/V content display on the A/V display device in a tiled window. Note that in order for the A/V display device to display the second A/V content, the A/V hub may convert or transform it from the TCP/IP communication protocol to the HDMI communication protocol or format.

This is shown in FIG. 5, which presents a drawing illustrating a display 500 in the A/V display device. In particular, second A/V content 516 may be presented in a tiled window 514, and first A/V content 512 may be presented (concurrently) in central window 510. Thus, there may be multiple independent real-time or live video streams presented or displayed in display 500.

When the A/V hub detects a type of change in second A/V content 516 (such as movement or a loud noise, e.g., a baby crying), the A/V hub may instruct (e.g., via display instructions for a display layout) the A/V display device to display second A/V content 516 in central window 510. This is shown in FIG. 6, which presents a drawing illustrating a display 600 in the A/V display device. In some embodiments, the A/V hub optionally instructs the A/V display device to display first A/V content 512 in optional tiled window 514 (e.g., via the display instructions). As noted previously, the type of change may be predefined or pre-specified (e.g., by the user). For example, when the user selects the security camera by activating an icon in a user interface displayed on a portable electronic device, the user may be presented with a set of predefined options for different types of change (motion such as when the baby is awake, sound such as when the baby is crying, a fire alarm, etc.) via the user interface, and the user may select one or more of the predefined options which are used by the A/V hub to dynamically analyze second A/V content 516. Alternatively or additionally, the A/V hub may automatically determine one or more types of change that it looks for when dynamically analyzing second A/V content 516. In particular, the A/V hub may determine the one or more types of change to look for based on: the location of the security camera, the time of day and/or the day of the week (and, more generally, based on a timestamp), a type of electronic device that provides second A/V content 516 (in this example, the security camera), a type of the second A/V content 516 (such as a sporting event, a television show, a concert, etc.), etc.

While FIG. 5 initially illustrated second A/V content 516 displayed in tiled window 514, in other embodiments second A/V content 516 is only displayed when one of the one or more targeted types of change are detected. Alternatively, when one of the one or more targeted types of change are detected, second A/V content 416 may then be displayed in central window 410 or tiled window 414. Thus, the display of tiled window 414 may be event driven, such as when a security or intrusion-detection device is triggered or when a baby monitor detects motion or a baby crying. In these cases, tiled window 414 with second A/V content 516 from a security camera or a baby camera may be automatically displayed. This may allow the user to visually assess whether further action is required.

In this way, the display technique may make it easier and more intuitive for a user to view different A/V content at the same time with a minimum of effort and with a reduced likelihood that the user will miss a major development or change in the second A/V content. In the process, the display technique may reduce user frustration, and thus may improve user satisfaction when using the portable electronic device, the A/V hub, and/or one or more A/V display devices. Consequently, method 200 (FIG. 2) may reduce user errors or mistakes when viewing the second A/V content, which may improve the user experience when using the portable electronic device and/or the A/V hub.

In some embodiments of method 200 there are additional or fewer operations. Moreover, the order of the operations may be changed, and/or two or more operations may be combined into a single operation. Furthermore, one or more operations may be modified. For example, additionally, display instructions may be provided to an A/V display device differentially (such as when the display instructions change), regularly or periodically (such as in one of every N packets or in a packet in each frame) or in each packet.

While the preceding embodiments illustrated tiled window 514 as being smaller than central window 510, in some embodiments tiled window 514 is the same size or larger than central window 510.

Note that in this display technique the A/V hub may display the A/V content to an arbitrary A/V display device (including an A/V display device that is located remotely from the A/V hub, such as in another room) without a need for a separate set-top box that is located proximate to the A/V display device. Instead, the A/V hub may perform all of the frame-by-frame transcoding of the video content that is needed for the A/V display device to display the video content before providing the video content to the A/V display device. Thus, in contrast with many existing cable and satellite systems, the A/V hub may provide video content to multiple A/V display devices (such as N A/V display devices) without the use of N associated set-top boxes. Consequently, the A/V hub may eliminate the need for a separate set-top box in the same room as an A/V display device (although there may be a local wireless receiver that is associated with the A/V hub). This capability may be enabled by the knowledge of the device state information and the content selected by the users that is available to the A/V hub. In addition, this capability may eliminate the need for a user to know where or how a particular A/V display device is connected to a content source, such as cable television, a satellite dish or a security camera.

We now describe embodiments of determining device-state information. As noted previously, the device-state information (such as whether an electronic device is: electrically coupled to A/V hub 112 in FIG. 1, in a power-on state, in a power-off state, and/or another state, e.g., a playback state, a pause state, a stop state, etc.) may be determined using hardware (such as a state-detection circuit) and/or software (which may be executed by a processor and, more generally, a control mechanism or a control circuit). FIG. 7 presents a block diagram illustrating a state-detection circuit 710 in A/V hub 112 (FIG. 1). In A/V hub 112 (FIG. 1), input connector 712 (which may be compatible with an HDMI standard) may be electrically coupled to an electronic device. State-detection circuit 710 may be coupled to at least pin 714 in input connector 712, so that, when the electronic device is electrically coupled to input connector 712, state-detection circuit 710 establishes a ground loop between A/V hub 112 (FIG. 1) and the electronic device. For example, pin 714 may include a transition minimized differential signaling (TMDS) data1 shield. (Alternatively, pin 714 may include a TMDS data1 shield.) Moreover, state-detection circuit 710 may include: an energy-dissipation component (such as resistor 716) electrically coupled to a power-supply voltage and pin 714 (which may provide electrostatic-discharge protection); an energy-storage component (such as capacitor 718) electrically coupled to pin 714 and ground; and a bi-directional voltage clamp (such as varistor 720 or a Verner diode), in parallel with capacitor 718, electrically coupled to pin 714 and ground. For example, resistor 716 may be 150 kΩ and capacitor 718 may be 0.047 μF. In some embodiments, state-detection circuit 710 includes a general-purpose input/output (GPIO) device 726 coupled to pin 714. The behavior (such as an input pin, an output pin, enabled or disabled) of GPIO device 726 may be controlled using control signals or instructions from control logic 724.

FIG. 8 presents a flow diagram illustrating a method 800 for detecting an electronic device, which may be performed by an A/V hub (such as A/V hub 112 in FIG. 1) using state-detection circuit 710 in FIG. 7. During operation, a control mechanism or a control circuit (such as a processor and/or control logic 724, which may be included in or external to state-detection circuit 710) in A/V hub 112 (FIG. 1), which is electrically coupled to input connector 712, detects whether there is electrical coupling between the electronic device and input connector 712 using state-detection circuit 710 (FIG. 7). In particular, detecting whether there is electrical coupling between the electronic device and input connector 712 may involve: setting pin 714 as an input (operation 810), where pin 714 is then pulled to a power-supply voltage by control logic 724; measuring a voltage on pin 714 (operation 812) using control logic 724; and detecting the electrical coupling between the electronic device and input connector 712 when the voltage on pin 714 is less than or equal to a predefined value (operation 814), such as when the voltage is approximately ground, using control logic 724. Note that, when the electrical coupling between the electronic device and input connector 712 is detected, control logic 724 may: set pin 714 as an output and electrically couple pin 714 to ground (operation 818), which may improve signal integrity; and measure a second voltage (operation 820) on hotplug-detect pin 722 in input connector 712. When the second voltage on hotplug-detect pin 722 is less than or equal to the predefined value (operation 822), control logic 724 may set pin 714 as an input (operation 824) and repeat the measurement of the voltage on pin 714 (operation 812). Alternatively, when the voltage equals or exceeds a second predefined value (operation 826), such as when the voltage is approximately the power-supply voltage, control logic 724 may repeat detecting whether there is electrical coupling between the electronic device and input connector 712. Furthermore, when the voltage is less than or equal to the predefined value (operation 814), control logic 724 may identify a current state (operation 816) of the electronic device, such as: a power-off state, and a standby state. For example, control logic 724 may provide the set of first control commands, provide the set of second control commands, and/or may monitor (via one or more pins in input connector 712) content activity, such as a data stream to and/or from the electronic device. Thus, control logic 724 may determine that the electronic device is: in the power-off state when there is no a data stream; in the standby state when the data stream has a low data rate; and in the playback state when the data stream has a data rate associated with A/V content and/or includes the A/V content. Note that, when the second voltage on hotplug-detect pin 722 is less than or equal to the predefined value (operation 822) and when the voltage is less than or equal to the predefined value (operation 814), control logic 724 may repeat setting pin 714 as the output and electrically coupling pin 714 to ground (operation 818).

When the electrical coupling between the electronic device and input connector 712 is detected, control logic 724 may optionally attempt to identify the electronic device by providing consumer-electronics-control commands (which may be compatible with an HDMI standard) to the electronic device. Alternatively or additionally (such as when the attempt is unsuccessful), control logic 724 may provide a set of first control commands associated with different types of electronic devices until, in response, content activity (such as packets or frames associated with a data stream of content communicated to and/or from the electronic device) is detected by control logic 724 via input connector 712. For example, the set of first commands may include: a play command for the different types of electronic devices; and/or a trick-mode command (such as fast forward, reverse, fast reverse, or skip) for the different types of electronic devices. Moreover, when the content activity is detected, control logic 724 may provide a set of second control commands associated with different providers of electronic devices until a change in a state of the electronic device is detected by control logic 724 via input connector 712 and state-detection circuit 710. The set of second control commands may include: power-on control commands for the different providers of electronic devices; and/or power-off control commands for the different providers of electronic devices.

Alternatively or additionally, during operation control logic 724 may detect whether there is electrical coupling between the electronic device and input connector 712 using state-detection circuit 710 (FIG. 7). When the electrical coupling between the electronic device and input connector 712 is detected, control logic 724 may: set pin 714 as an output and electrically couple pin 714 to ground; and measure the second voltage on hotplug-detect pin 722 in input connector 712. When the second voltage on hotplug-detect pin 722 is less than or equal to the predefined value, control logic 724 may set pin 714 as an input and measure a voltage on pin 714. Moreover, when the voltage equals or exceeds the second predefined value, control logic 724 may repeat detecting whether there is electrical coupling between the electronic device and input connector 712. Furthermore, when the voltage is less than or equal to the predefined value, control logic 724 may identify the current state of the electronic device. In some embodiments, control logic 724: provides a control command to the electronic device; and identifies an additional state of the electronic device based on content (such as A/V content) that is provided and/or received by the electronic device in response to the control command. For example, the control command may include: a play command, and/or a trick-mode command (such as fast forward or fast skip, slow forward or slow skip, fast reverse, or slow reverse).

We now describe embodiments of an electronic device. FIG. 9 presents a block diagram illustrating an electronic device 900, such as portable electronic device 110, A/V hub 112, A/V display device 114-1 or one of speakers 116 in FIG. 1. This electronic device includes processing subsystem 910, memory subsystem 912, networking subsystem 914 and optional feedback subsystem 934. Processing subsystem 910 includes one or more devices configured to perform computational operations. For example, processing subsystem 910 can include one or more microprocessors, application-specific integrated circuits (ASICs), microcontrollers, programmable-logic devices, and/or one or more digital signal processors (DSPs). One or more of these components in processing subsystem are sometimes referred to as a ‘control mechanism’ or a ‘control circuit.’

Memory subsystem 912 includes one or more devices for storing data and/or instructions for processing subsystem 910 and networking subsystem 914. For example, memory subsystem 912 can include dynamic random access memory (DRAM), static random access memory (SRAM), and/or other types of memory. In some embodiments, instructions for processing subsystem 910 in memory subsystem 912 include: one or more program modules or sets of instructions (such as program module 922 or operating system 924), which may be executed by processing subsystem 910. Note that the one or more computer programs or program modules may constitute a computer-program mechanism. Moreover, instructions in the various modules in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in electronic device 900. In some of these embodiments, one or more of the caches is located in processing subsystem 910.

In some embodiments, memory subsystem 912 is coupled to one or more high-capacity mass-storage devices (not shown). For example, memory subsystem 912 can be coupled to a magnetic or optical drive, a solid-state drive, or another type of mass-storage device. In these embodiments, memory subsystem 912 can be used by electronic device 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, interface circuits 918 and associated antennas 920. (While FIG. 9 includes antennas 920, in some embodiments electronic device 900 includes one or more nodes, such as nodes 908, e.g., pads, which can be coupled to antennas 920. Thus, electronic device 900 may or may not include antennas 920.) For example, networking subsystem 914 can include a Bluetooth networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system. Note that the combination of a given one of interface circuits 918 and at least one of antennas 920 may constitute a radio. In some embodiments, networking subsystem 914 includes a wired interface, such as HDMI interface 930 (which may include a state-detection circuit).

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 900 may use the mechanisms in networking subsystem 914 for performing simple wireless communication between the electronic devices, e.g., transmitting advertising or beacon frames and/or scanning for advertising frames transmitted by other electronic devices as described previously.

Within electronic device 900, processing subsystem 910, memory subsystem 912, networking subsystem 914 and optional feedback subsystem 934 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, electronic device 900 includes a display subsystem 926 for displaying information on a display (such as the communication warning message), which may include a display driver, an I/O controller and the display. Note that a wide variety of display types may be used in display subsystem 926, including: a two-dimensional display, a three-dimensional display (such as a holographic display or a volumetric display), a head-mounted display, a retinal-image projector, a heads-up display, a cathode ray tube, a liquid-crystal display, a projection display, an electroluminescent display, a display based on electronic paper, a thin-film transistor display, a high-performance addressing display, an organic light-emitting diode display, a surface-conduction electronic-emitter display, a laser display, a carbon-nanotube display, a quantum-dot display, an interferometric modulator display, a multi-touch touchscreen (which is sometimes referred to as a touch-sensitive display), and/or a display based on another type of display technology or physical phenomenon.

Furthermore, optional feedback subsystem 934 may include one or more sensor-feedback mechanisms or devices, such as: a vibration mechanism or a vibration actuator (e.g., an eccentric-rotating-mass actuator or a linear-resonant actuator), a light, one or more speakers, etc., which can be used to provide feedback to a user of electronic device 900 (such as sensory feedback about the status of a user instruction to change the state of one of the components in system 100 in FIG. 1).

Electronic device 900 can be (or can be included in) any electronic device with at least one network interface. For example, electronic device 900 can be (or can be included in): a desktop computer, a laptop computer, a subnotebook/netbook, a server, a tablet computer, a smartphone, a cellular telephone, a consumer-electronic device (such as a television, a set-top box, audio equipment, video equipment, etc.), a remote control, a portable computing device, an access point, a router, a switch, communication equipment, test equipment, and/or another electronic device.

Although specific components are used to describe electronic device 900, in alternative embodiments, different components and/or subsystems may be present in electronic device 900. For example, electronic device 900 may include one or more additional processing subsystems, memory subsystems, networking subsystems, and/or display subsystems. Moreover, while one of antennas 920 is shown coupled to a given one of interface circuits 918, there may be multiple antennas coupled to the given one of interface circuits 918. For example, an instance of a 3×3 radio may include three antennas. Additionally, one or more of the subsystems may not be present in electronic device 900. Furthermore, in some embodiments, electronic device 900 may include one or more additional subsystems that are not shown in FIG. 9. Also, although separate subsystems are shown in FIG. 9, in some embodiments, some or all of a given subsystem or component can be integrated into one or more of the other subsystems or component(s) in electronic device 900. For example, in some embodiments program module 922 is included in operating system 924.

Moreover, the circuits and components in electronic device 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 914, such as one or more radios. Moreover, the integrated circuit may include hardware and/or software mechanisms that are used for transmitting wireless signals from electronic device 900 and receiving signals at electronic device 900 from other electronic devices. Aside from the mechanisms herein described, radios are generally known in the art and hence are not described in detail. In general, networking subsystem 914 and/or the integrated circuit can include any number of radios.

In some embodiments, networking subsystem 914 and/or the integrated circuit include a configuration mechanism (such as one or more hardware and/or software mechanisms) that configures the radios to transmit and/or receive on a given channel (e.g., a given carrier frequency). For example, in some embodiments, the configuration mechanism can be used to switch the radio from monitoring and/or transmitting on a given channel to monitoring and/or transmitting on a different channel. (Note that ‘monitoring’ as used herein comprises receiving signals from other electronic devices and possibly performing one or more processing operations on the received signals, e.g., determining if the received signal comprises an advertising frame, calculating a performance metric, performing spectral analysis, etc.) Furthermore, networking subsystem 914 may include at least one port (such as an HDMI port 932) to receive and/or provide the information in the data stream to A/V display device 114-1 (FIG. 1) and/or one of the one or more content sources 126 (FIG. 1).

While a communication protocol compatible with Wi-Fi was used as an illustrative example, the described embodiments may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the display technique may be implemented using program module 922, operating system 924 (such as drivers for interface circuits 918) and/or in firmware in interface circuits 918. Alternatively or additionally, at least some of the operations in the display technique may be implemented in a physical layer, such as hardware in interface circuits 918.

Moreover, while the preceding embodiments included a touch-sensitive display in the portable electronic device that the user touches (e.g., with a finger or digit, or a stylus), in other embodiments the user interface is display on a display in the portable electronic device and the user interacts with the user interface without making contact or touching the surface of the display. For example, the user's interact(s) with the user interface may be determined using time-of-flight measurements, motion sensing (such as a Doppler measurement) or another non-contact measurement that allows the position, direction of motion and/or speed of the user's finger or digit (or a stylus) relative to position(s) of one or more virtual command icons to be determined. In these embodiments, note that the user may activate a given virtual command icon by performing a gesture (such as ‘tapping’ their finger in the air without making contact with the surface of the display). In some embodiments, the user navigates through the user interface and/or activates/deactivates functions of one of the components in system 100 (FIG. 1) using spoken commands or instructions (i.e., via voice recognition) and/or based on where they are looking in the visual feedback displayed on A/V display device 114-1 in FIG. 1 (e.g., by tracking the user's gaze or where the user is looking).

Furthermore, while A/V hub 112 (FIG. 1) was illustrated as a separate component from A/V display device 114-1 (FIG. 1), in some embodiments the components are combined into a single component or a single electronic device.

While the preceding embodiments illustrated the display technique with audio and video content (such as HDMI content), in other embodiments the display technique is used in the context of an arbitrary type of data or information. For example, the display technique may be used with home-automation data. In these embodiments, A/V hub 112 (FIG. 1) may facilitate communication among and control of a wide variety of electronic devices, including electronic devices in addition to or other than electronic devices, monitoring devices or security devices. Thus, A/V hub 112 (FIG. 1) and the display technique may be used to facilitate or implement services in the so-called Internet of things.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
one or more antennas;
an interface circuit communicatively coupled to the one or more antennas, wherein the electronic device is configured to:
generate first display instructions specifying a first display layout on a display in a display device, wherein the first display layout includes first content from a first content source displayed in a central window of the display and second content from a second content source displayed in a tiled window of the display, wherein the tiled window is located proximate to a periphery of the display;
provide, via the interface circuit, the first display instructions, the first content and the second content for the display device;
determine a type of change based on at least one of: a location of the second content source, a timestamp, a type of the second content source, and a type of the second content;
analyze the second content to identify the type of change in the second content;
generate second display instructions specifying a second display layout on the display based on the analysis, wherein the second display layout includes the second content displayed in the central window; and
provide, via the interface circuit, the second display instructions and the second content for the display device.

2. The electronic device of claim 1, wherein the type of change includes an increase in an audio volume in the second content exceeding a threshold value.

3. The electronic device of claim 2, wherein the audio volume is associated with one of: crowd noise at an entertainment event; a child crying; and a door bell.

4. The electronic device of claim 1, wherein the type of change includes motion in an environment.

5. The electronic device of claim 1, wherein the type of change includes a hazardous condition.

6. The electronic device of claim 1, wherein the second content is received via the interface circuit using a Transmission Control Protocol/Internet Protocol (TCP/IP) communication protocol; and
wherein the electronic device is configured to transform the second content to a different communication protocol prior to providing the second content for the display device.

7. The electronic device of claim 1, wherein the electronic device is configured to determine the first display instructions and the second display instructions based on a format of the display.

8. The electronic device of claim 1, wherein at least one of the first content and the second content includes high-definition multimedia-interface (HDMI) content, and the second content is provided, via the interface circuit, for the display device as frames with the second content are received via the interface circuit; and
wherein the second content is to be displayed on the display in the display device concurrently with the first content.

9. The electronic device of claim 1, wherein the second display layout includes the first content displayed in the tiled window; and
wherein, when providing the second display instructions and the second content, the control circuit provides, via the interface circuit, the first content for the display device.

10. The electronic device of claim 1, wherein the electronic device further comprises:
a processor; and
a memory, coupled to the processor, which stores a program module, wherein, when executed by the processor, the program module causes the electronic device to perform one or more of: the generating of the first display instructions, the providing of the first display instructions, the determining of the type of change, the analyzing of the second content, the generating of the second display instructions, and the providing of the second display instructions.

11. A non-transitory computer-readable storage medium for use in conjunction with an electronic device, the computer-readable storage medium storing a program module that, when executed by the electronic device, adapts displayed content by performing one or more operations comprising:
generating first display instructions specifying a first display layout on a display in a display device, wherein the first display layout includes first content from a first content source displayed in a central window of the display and second content from a second content source displayed in a tiled window of the display, wherein the tiled window is located proximate to a periphery of the display;
providing, via an interface circuit in the electronic device, the first display instructions, the first content and the second content for the display device;
determining a type of change based on at least one of: a location of the second content source, a timestamp, a type of the second content source, and a type of the second content;
analyzing the second content to identify the type of change in the second content;
generating second display instructions specifying a second display layout on the display based on the analysis, wherein the second display layout includes the second content displayed in the central window; and
providing, via the interface circuit, the second display instructions and the second content for the display device.

12. The computer-readable storage medium of claim 11, wherein the type of change includes an increase in an audio volume in the second content exceeding a threshold value.

13. The computer-readable storage medium of claim 12, wherein the audio volume is associated with one of: crowd noise at an entertainment event; a child crying; and a door bell.

14. The computer-readable storage medium of claim 11, wherein the type of change includes one of: motion in an environment; and a hazardous condition.

15. The computer-readable storage medium of claim 11, wherein the second content is received using a Transmission Control Protocol/Internet Protocol (TCP/IP) communication protocol; and
wherein the one or more operations comprise transforming the second content to a different communication protocol prior to providing the second content for the display device.

16. The computer-readable storage medium of claim 11, wherein one or more operations comprise determining the first display instructions and the second display instructions based on a format of the display.

17. The computer-readable storage medium of claim 11, wherein at least one of the first content and the second content includes high-definition multimedia-interface (HDMI) content and the second content is provided, via the interface circuit, for the display device as frames with the second content are received from the interface circuit; and
wherein the second content is to be displayed on the display in the display device concurrently with the first content

18. A method for adapting displayed content, wherein the method comprises:
by an electronic device:
generating first display instructions specifying a first display layout on a display in a display device, wherein the first display layout includes first content from a first content source displayed in a central window of the display and second content from a second content source displayed in a tiled window of the display, wherein the tiled window is located proximate to a periphery of the display;
providing, via an interface circuit in the electronic device, the first display instructions, the first content and the second content for the display device;
determining a type of change based on at least one of: a location of the second content source, a timestamp, a type of the second content source, and a type of the second content;
analyzing the second content to identify the type of change in the second content;
generating second display instructions specifying a second display layout on the display based on the analysis, wherein the second display layout includes the second content displayed in the central window; and
providing, via the interface circuit, the second display instructions and the second content for the display device.

19. The method of claim 18, wherein the second content is received using a Transmission Control Protocol/Internet Protocol (TCP/IP) communication protocol; and
wherein the method further comprises transforming the second content to a different communication protocol prior to providing the second content for the display device.

20. The method of claim 18, wherein the method further comprises determining the first display instructions and the second display instructions based on a format of the display.
